(19) United States
(12) Patent Application Publication
(10) Pub. No.: US 2025/0078802 A1
(43) Pub. Date: Mar. 6, 2025

(54) METHOD AND SYSTEM FOR ESTIMATING ACTIVE NOISE CONTROL PERFORMANCE OF VEHICLES

(71) Applicants: HYUNDAI MOTOR COMPANY, SEOUL (KR); KIA CORPORATION, SEOUL (KR)

(72) Inventors: Jea Kwan Kim, Anyang-si (KR); Bo Yong Kim, Seoul (KR)

(21) Appl. No.: 18/606,273

(22) Filed: Mar. 15, 2024

(30) Foreign Application Priority Data
Aug. 28, 2023 (KR) 10-2023-0112996

(51) Int. Cl. G10K 11/178

(52) U.S. Cl. CPC G10K 11/17833; G10K 11/17817; G10K 11/17883; G10K 2210/12821; G10K 2210/30231; G10K 2210/3026; G10K 2210/3027; G10K 2210/3028; G10K 2210/501

(57) ABSTRACT

A method of estimating active noise control performance of a vehicle includes performing ANC by reproducing an acoustic signal for reducing noise introduced from the outside to the inside of the vehicle through a speaker and receiving a residual signal remaining after noise reduction from a microphone, generating an estimation signal for a control signal for controlling output of the speaker such that the acoustic signal is reproduced during the ANC, generating an estimation signal for original noise before the ANC based on the residual signal and the estimation signal for the control signal, and estimating noise reduction performance based on the estimation signal for the original noise and the residual signal.

### CROSS REFERENCE TO RELATED APPLICATIONS

This application claims priority to Korean Patent Application No. 10-2023-0112996, filed on Aug. 28, 2023 in the Korean Intellectual Property Office, the disclosure of which is incorporated herein by reference.

### BACKGROUND

### 1. Field

The present disclosure relates to an active noise control system for vehicles, and more specifically, to a method and system for estimating the active noise control performance of vehicles.

### 2. Description of the Related Art

Active noise control (ANC) systems attenuate unwanted noise using feedforward and feedback structures to adaptively remove unwanted noise within a listening environment, such as inside a vehicle cabin. ANC systems typically cancel or reduce unwanted noise by generating canceling sound waves for destructively interfering with unwanted audible noise. In canceling interference, noise and “anti-noise” which is approximately equal in magnitude but opposite in phase reduce a sound pressure level (SPL) at a certain location. In a vehicle cabin listening environment, potential sources of unwanted noise come from sounds radiated by the engine, interaction between the tires of the vehicle and a road surface on which the vehicle is traveling, and/or sound due to vibrations of other parts of the vehicle. Accordingly, unwanted noise varies depending on speed, road conditions and driving conditions of the vehicle.

An active noise control system for vehicles is always operated in the ON state after vehicle production, and it is impossible to measure a noise level with the active noise control system turned off, and thus the noise reduction performance of the active noise control system can be estimated.

Therefore, in this technical field, there is a need for a technique for estimating noise reduction performance without turning off the active noise control system of a vehicle even while the active noise control system is in the ON state.

### SUMMARY

An object of the present disclosure is to estimate noise reduction performance without turning off an active noise control system for vehicles even while the system is in an ON state.

Another object of the present disclosure is to provide active noise control performance in real time.

Yet another object of the present disclosure is to monitor performance and stability deterioration due to long-term operation of the active noise control system.

Further another object of the present disclosure is to provide information by which a past operation history can be checked at the time of maintaining an active noise control system to aid in function development, improvement, and maintenance.

The object of the present disclosure is not limited to the object mentioned above, and other objects not mentioned will be clearly understood by those skilled in the art from the following description.

In accordance with an aspect of the present disclosure, the above and other objects can be accomplished by the provision of a method of estimating active noise control performance of a vehicle performed by an active noise control (ANC) system, the method includes performing ANC by reproducing an acoustic signal for reducing noise introduced from the outside to the inside of the vehicle through a speaker and receiving a residual signal remaining after noise reduction from a microphone, generating an estimation signal for a control signal for controlling output of the speaker such that the acoustic signal is reproduced during the ANC, generating an estimation signal for original noise before the ANC on the basis of the residual signal and the estimation signal for the control signal, and estimating noise reduction performance on the basis of the estimation signal for the original noise and the residual signal.

Here, the estimation signal for the original noise may be generated by summing the residual signal and the estimation signal for the control signal.

Here, the estimation signal for the control signal may be generated by a secondary path model filter on the basis of an output signal of an active filter.

Here, the output signal of the active filter may be generated by the active filter on the basis of a reference signal generated by an accelerometer, a reference signal filtered by the secondary path model filter, and a residual signal remaining after noise reduction.

Here, the noise reduction performance may be estimated using a value obtained by subtracting a sound pressure level of the residual noise from a sound pressure level of the estimation signal for the original noise.

In accordance with another aspect of the present disclosure, there is provided an active noise control system for a vehicle, including a processor configured to perform active noise control (ANC) by reproducing an acoustic signal for reducing noise introduced from the outside to the inside of the vehicle through a speaker and receive a residual signal remaining after noise reduction from a microphone, generate an estimation signal for a control signal for controlling output of the speaker such that the acoustic signal is reproduced during the ANC, generate an estimation signal for original noise before the ANC on the basis of the residual signal and the estimation signal for the control signal, and estimate noise reduction performance on the basis of the estimation signal for the original noise.

Here, the estimation signal for the original noise may be generated by summing the residual signal and the estimation signal for the control signal.

Here, the estimation signal for the control signal may be generated by a secondary path model filter on the basis of an output signal of an active filter.

Here, the output signal of the active filter may be generated by the active filter on the basis of a reference signal generated by an accelerometer, a reference signal filtered by the secondary path model filter, and a residual signal remaining after noise reduction.

Here, the noise reduction performance may be estimated using a value obtained by subtracting a sound pressure level of the residual noise from a sound pressure level of the estimation signal for the original noise.

### BRIEF DESCRIPTION OF THE FIGURES

The above and other objects, features and other advantages of the present disclosure will be more clearly understood from the following detailed description taken in conjunction with the accompanying drawings, in which:

FIG. 1 shows an example of a typical active noise control (ANC) system;

FIG. 2 shows an ANC system according to an embodiment of the present disclosure;

FIG. 3 shows an ANC according to another embodiment of the present disclosure;

FIG. 4 shows an example of active noise control performance of a vehicle that can be displayed on a display screen of an input/output interface according to an embodiment of the present disclosure;

FIG. 5 is a flowchart showing an ANC method according to an embodiment of the present disclosure; and

FIG. 6 shows a computer system according to an embodiment of the present disclosure.

### DETAILED DESCRIPTION

The present disclosure will be described in detail with reference to the attached drawings as follows. Here, repeated descriptions, and detailed description of known functions and configurations that may unnecessarily obscure the gist of the present disclosure will be omitted. Embodiments of the present disclosure are provided to more completely explain the present disclosure to those skilled in the art. Accordingly, the shapes and sizes of elements in the drawings may be exaggerated for clearer explanation.

Hereinafter, preferred embodiments according to the present disclosure will be described in detail with reference to the attached drawings.

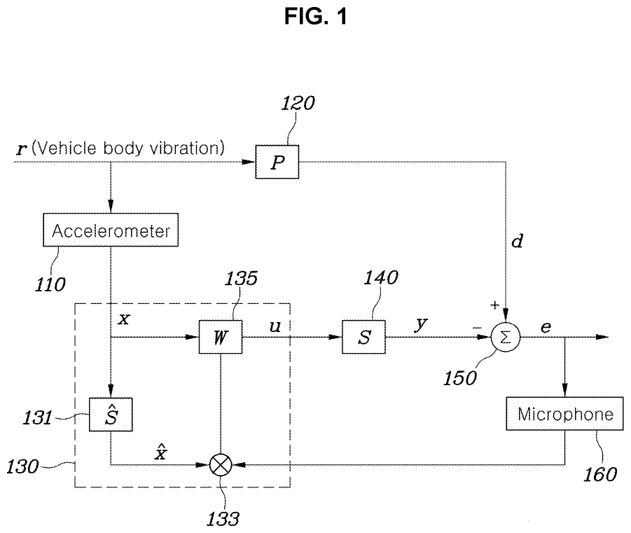

FIG. 1 shows an example of a typical active noise control (ANC) system.

Referring to FIG. 1, a typical ANC system includes an accelerometer 110, a primary path filter 120, a processor 130, a secondary path filter 140, a comparator 150, and a microphone 160.

The accelerometer 110 detects vehicle body vibration y from a road surface, generates a reference signal x, and transmits the generated reference signal x to the processor 130.

The primary path filter 120 transmits the vehicle body vibration y to the microphone 160 in the form of original noise d before control.

The processor 130 calculates an adaptive algorithm by Filtered Least Mean Square (FxLMS) based on the reference signal x generated by the accelerometer 110, outputs a signal, and performs signal processing in a digital domain such as filtering a secondary path model.

Here, the processor 130 may be a digital signal processor (DSP).

A secondary path model filter 131 estimates a transfer function for a secondary path of the secondary path filter 140 and generates a filtered reference signal î on the basis of the reference signal x.

The controller 133 transmits the estimated reference signal x received from the secondary path model filter 131 and residual noise received from the microphone 160 to an active filter 135.

The active filter 135 generates an active filter output signal u on the basis of the reference signal x received from the accelerometer 110, the filtered reference signal î generated by the secondary path model filter 133, and controlled residual noise e received from the microphone 160.

Here, an FxLMS filter coefficient may be updated in real time by the active filter 135.

The secondary path filter 140 generates a speaker output control signal y on the basis of the output signal u from the active filter 135.

Here, the output control signal y generated by the secondary path filter 140 is a sound wave with the same magnitude and opposite phase as the original noise d before control and may be a signal for reducing the original noise d before control.

The comparator 150 transmits the controlled residual noise e obtained by subtracting the speaker output control signal y from the secondary path filter 140 from the original noise d before control from the primary path filter 120 to the microphone 160.

The microphone 160 detects the controlled residual noise e and transmits the same to the processor 230.

Meanwhile, in the ANC system as shown in FIG. 1, merely the controlled residual noise e obtained by canceling the speaker output control signal y by the residual noise d before control can be measured, and the original noise d before control cannot be measured. However, the noise removal performance of the active noise control system can be estimated using a value obtained by subtracting the sound pressure level of the controlled residual noise e from the sound pressure level of the original noise d before control. Therefore, in situations in which the original noise d before control is unknown, the noise removal performance of the active noise control system cannot be estimated.

Hereinafter, an active noise control system according to an embodiment of the present disclosure which can estimate the noise removal performance of the active noise control system by estimating the original noise d before control even in a state in which the active noise control system is turned on will be described.

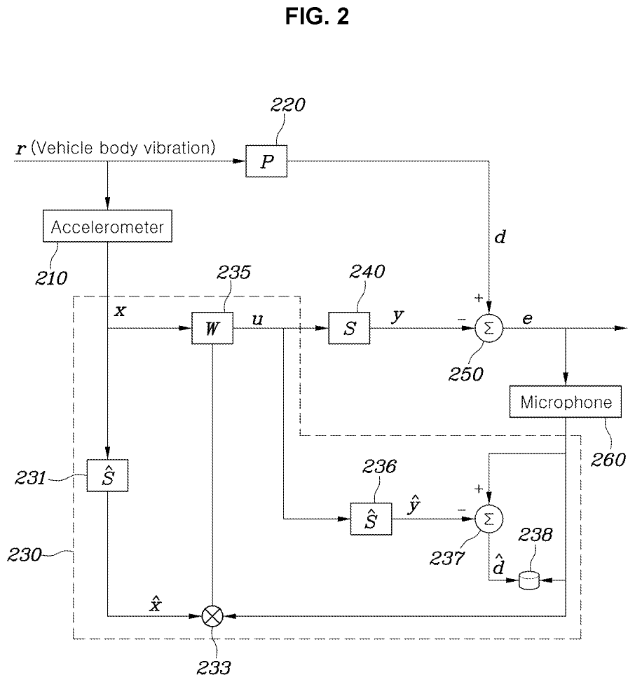

FIG. 2 shows an ANC system according to an embodiment of the present disclosure.

Referring to FIG. 2, the ANC system according to the present embodiment includes an accelerometer 210, a primary path filter 220, a processor 230, a secondary path filter 240, a summer 250, and a microphone 260.

The accelerometer 210 detects vehicle body vibration γ from a road surface, generates a reference signal x, and transmits the generated reference signal x to the processor 230.

The primary path filter 220 transmits the vehicle body vibration γ to the microphone 260 in the form of original noise d before control.

The processor 230 calculates an adaptive algorithm by Filtered Least Mean Square (FxLMS) on the basis of the reference signal x generated by the accelerometer 210, outputs a signal, and performs signal processing in a digital domain such as filtering a secondary path model.

A first secondary path model filter 231 estimates a transfer function for a secondary path of the secondary path filter 240 and generates a filtered reference signal \hat{x} on the basis of the reference signal x.

The controller 233 transmits the estimated reference signal \hat{x} received from the secondary path model filter 231 and residual noise received from the microphone 260 to an active filter 235.

The active filter 235 generates an active filter output signal u on the basis of the reference signal x received from the accelerometer 210, the filtered reference signal \hat{x} generated by the secondary path model filter 233, and residual noise e after control received from the microphone 260.

Here, a filtered least mean square (FxLMS) filter coefficient may be updated in real time by the active filter 235.

A second secondary path model filter 236 estimates a transfer function for the secondary path of the secondary path filter 240 and generates an estimation signal ŷ for a speaker output control signal y on the basis of the output signal u.

Here, the second secondary path model filter 236 is a filter integrated with the first secondary path model filter 231 and can perform the functions of the first secondary path model filter 231 and the second secondary path model filter 236 simultaneously.

A summer 237 sums the estimation signal ŷ for the control signal generated by the second secondary path model filter 236 and the residual noise e after control received from the microphone 260 to generate an estimation signal \hat{d} for the original noise before control.

Here, the estimation signal for the original noise before control may be estimated as a value close to the original noise before control, as represented by mathematical expression 1 below.

$$\hat{d} - e + \hat{y} = d - y + \hat{y} \approx d ( ∵ \hat{y} \approx y ) \qquad Mathematical expression 1$$

In mathematical expression 1, \hat{d} represents the estimation signal for the original noise before control, e represents controlled residual noise, y represents a control signal for controlling speaker output, and ŷ represents the estimation signal for the control signal for controlling the speaker output.

A storage unit 238 stores the controlled residual noise e or the estimation signal \hat{d} for the original noise before control.

Here, the storage unit 238 may be various types of volatile or non-volatile storage media.

The secondary path filter 240 generates a speaker output control signal y on the basis of the output signal u of the active filter 235.

Here, the output control signal y generated by the secondary path filter 240 is a sound wave with the same magnitude and opposite phase to the original noise d before control and may be a signal for reducing the original noise d before control.

The comparator 250 transmits controlled residual noise e obtained by subtracting the speaker output control signal y from the secondary path filter 240 from the original noise d before control from the primary path filter 220 to the microphone 260.

The microphone 260 detects the controlled residual noise e and transmits the same to the processor 230.

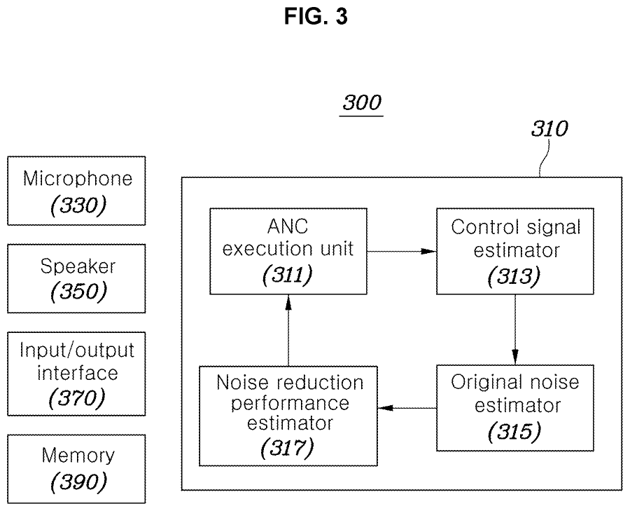

FIG. 3 shows an active noise control system 300 according to another embodiment of the present disclosure.

Referring to FIG. 3, the active noise control system 100 according to the present embodiment includes a processor 310, a microphone 330, a speaker 350, an input/output interface 370, and a memory 390.

The processor 310 includes a control signal estimator 313, an original noise estimator 315, and a noise reduction performance estimator 317.

The control signal estimator 313 performs ANC by outputting an acoustic signal for reducing noise introduced from outside the vehicle to the inside through a speaker, and generates an estimation signal for a control signal for controlling output of the speaker such that the acoustic signal is output at the time of performing ANC.

Here, the estimation signal for the control signal may be generated by a secondary path model filter on the basis of the output signal u of the active filter.

Here, the secondary path model filter may be generated by estimating a transfer function for the secondary path of the secondary path filter.

Here, the output signal u of the active filter may be generated on the basis of the reference signal x received from the accelerometer, the filtered reference signal \hat{x} generated by the secondary path model filter 233, and the controlled residual noise after control e received from the microphone.

The original noise estimator 315 receives a residual signal remaining after noise reduction from the microphone 330, receives the estimation signal for the control signal for controlling speaker output from the control signal estimator 313, and generates an estimation signal for the original noise on the basis of the residual signal and the estimate signal for the control signal.

Here, the estimation signal for the original noise generated by the original noise estimator 315 may be transmitted to the memory 390 for storage.

The noise reduction performance estimator 317 estimates noise reduction performance on the basis of the estimation signal for the original noise.

Here, the noise reduction performance may be estimated using a value obtained by subtracting the sound pressure level of the controlled residual noise e from the sound pressure level of the estimation signal d for the original noise before control.

Here, the noise reduction performance estimator 317 transmits the noise reduction performance estimation result to the input/output interface 370 such that the noise reduction performance estimation result can be provided to an occupant inside the vehicle through the input/output interface 370.

Additionally, the noise reduction performance estimation result generated by the noise reduction performance estimator 317 may be transmitted to the memory 390 for storage.

At least one microphone 330 is disposed inside the vehicle to detect external noise generated due to interaction between the tires of the vehicle and a road surface.

Here, the microphone 330 may be provided, for example, in a headrest of a seat, and may be disposed in an automobile headliner or various places to detect noise outside the vehicle.

The speaker 350 reproduces an anti-noise signal for signals received by the microphone 330, generated by the processor 310.

The input/output interface 370 provides noise reduction performance estimated by the noise reduction performance estimator 317 to an occupant inside the vehicle.

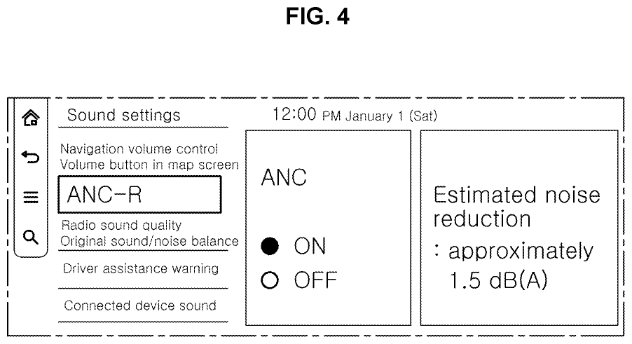

For example, the input/output interface 370 provides noise reduction performance estimation results to the occupant inside the vehicle through a display screen as shown in FIG. 4.

The memory 390 may be various types of volatile or non-volatile storage media. Here, the memory 390 stores at least one of an estimation signal for a control signal for controlling speaker output, an estimation signal for original noise, noise reduction performance estimation results, or a combination thereof.

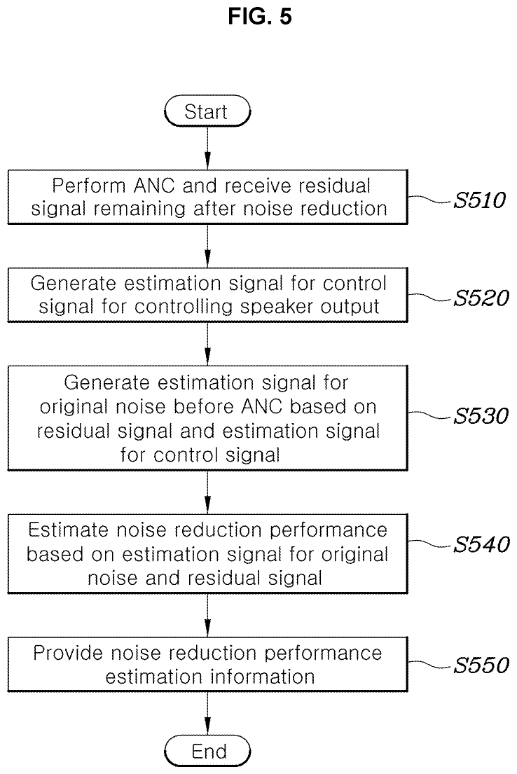

FIG. 5 is a flowchart showing an active noise control (ANC) method according to an embodiment of the present disclosure. The active noise control method according to the present embodiment can be performed by the processor 310 of FIG. 3.

Referring to FIG. 5, the processor 310 performs active noise control (ANC) by reproducing an acoustic signal for reducing noise introduced from the outside of the vehicle to the inside through a speaker, and receives a residual signal remaining after noise reduction from the microphone at S510.

For example, the processor 310 generates a sound wave with the same magnitude and opposite phase to the noise outside the vehicle to be transmitted to an occupant inside the vehicle and reproduces the sound wave through the speaker 250 to reduce the noise outside the vehicle.

Here, the processor 310 may reduce the noise outside the vehicle using an actual secondary path S(s) which is an electrical and acoustic path between the speaker 350 and the microphone 330 and a secondary path model algorithm using a secondary path model § which is a digital filter obtained by measuring the actual secondary path by a DSP and modeling the same into a transfer function.

Additionally, the processor 310 generates an estimation signal for a control signal for controlling output of the speaker such that the acoustic signal is reproduced during the ANC at S520.

Here, the estimation signal for the control signal may be generated by a secondary path model filter on the basis of the output signal of the active filter.

Here, the output signal of the active filter may be generated by the active filter on the basis of a reference signal generated by the accelerometer, a reference signal filtered by the secondary path model filter, and the residual signal remaining after noise reduction.

Additionally, the processor 310 generates an estimation signal for the original noise before the ANC on the basis of the residual signal and the estimation signal for the control signal at S530.

Here, the estimation signal for the original noise may be generated by summing the residual signal and the estimation signal for the control signal.

Additionally, the processor 310 estimates noise reduction performance on the basis of the estimation signal for the original noise at S540.

Here, the noise reduction performance may be estimated using a value obtained by subtracting the sound pressure level of the controlled residual noise e from the sound pressure level of the estimation signal d for the original noise before control.

Additionally, the processor 310 provides noise reduction performance estimation results to the occupant inside the vehicle at S550.

Here, the processor 310 transmits the noise reduction performance estimation results to the input/output interface 370 and can provide the noise reduction performance estimation results to the occupant inside the vehicle through the input/output interface 370.

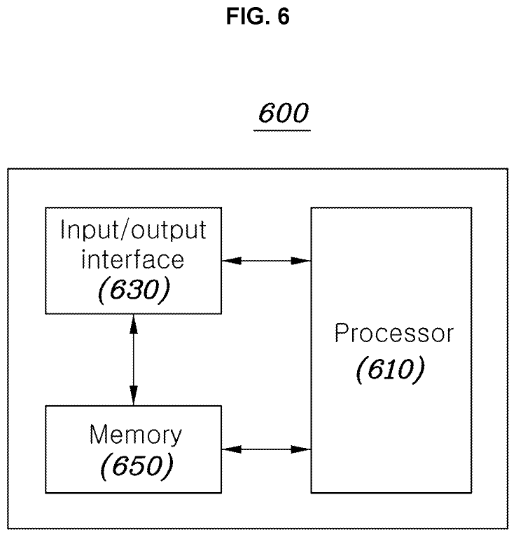

FIG. 6 shows a computer system according to an embodiment of the present disclosure.

Referring to FIG. 6, embodiments of the present disclosure may be implemented in a computer system such as a computer-readable recording medium. As shown in FIG. 6, the computer system 600 includes a processor 610, an input/output interface 630, and a memory 650.

The processor 610 implements the active noise control performance estimation method for vehicles proposed in this specification. Specifically, the processor 610 implements all operations of the processor 310 in the active noise control system 300 described in the embodiment of the present disclosure and performs all operations of the active noise control performance estimation method according to FIG. 5.

For example, the processor 610 performs ANC by reproducing an acoustic signal for reducing noise introduced from the outside of the vehicle to the inside through a speaker, receives a residual signal remaining after noise reduction from the microphone, generates an estimation signal for a control signal for controlling output of the speaker such that the acoustic signal is reproduced during the ANC, generates an estimation signal for original noise before ANC on the basis of the residual signal and the estimation signal for the control signal, and estimates noise reduction performance on the basis of the estimation signal for the original noise.

Here, the estimation signal for the original noise may be generated by summing the residual signal and the estimation signal for the control signal.

Here, the estimation signal for the control signal may be generated by a secondary path model filter on the basis of the output signal of an active filter.

Here, the output signal of the active filter may be generated by the active filter on the basis of a reference signal generated by an accelerometer, a reference signal filtered by the secondary path model filter, and a residual signal remaining after noise reduction.

Here, the noise reduction performance may be estimated using a value obtained by subtracting the sound pressure level of the residual noise from the sound pressure level of the estimation signal for the original noise.

The input/output interface 630 is connected to the processor 610 and directly obtains information or provides information to a user. For example, the input/output interface 630 provides noise reduction performance estimation results to an occupant inside the vehicle.

The memory 650 may be various types of volatile or non-volatile storage media. Here, the memory 650 stores at least one of an estimation signal for a control signal for controlling speaker output, an estimation signal for original noise, noise reduction performance estimation results, or a combination thereof.

According to the above-described embodiments of the present disclosure, it is possible to estimate noise reduction performance in real time and store a performance history without turning off an active noise control system even while the system is in an ON state and without affecting usability.

Furthermore, it is possible to provide the effects of an active noise control function to customers using objective numerical values.

Furthermore, it is possible to monitor performance and stability deterioration due to long-term operation of the active noise control system.

Furthermore, it is possible to check information by which a past operation history can be checked at the time of maintaining an active noise control system to aid in function development, improvement, and maintenance.

The above-described present disclosure may be implemented as computer-readable code on a program-recorded medium. Computer-readable media includes all types of recording devices that store data that can be read by a computer system. Examples of computer-readable media include a hard disk drive (HDD), a solid state drive (SSD), a silicon disk drive (SDD), a ROM, a RAM, a CD-ROM, a magnetic tape, a floppy disk, an optical data storage device, and the like.

Accordingly, the above detailed description should not be construed as restrictive in all respects and should be considered illustrative. The scope of the present disclosure should be determined by reasonable interpretation of the appended claims, and all changes within the equivalent scope of the present disclosure are included in the scope of the present disclosure.

1. A method of estimating active noise control (ANC) performance of a vehicle performed by an active noise control (ANC) system, the method comprising:
performing, by a processor, ANC by reproducing an acoustic signal for reducing noise introduced from an outside to an inside of the vehicle through a speaker, and receiving a residual signal remaining after noise reduction from a microphone;
generating an estimation signal for a control signal for controlling output of the speaker such that the acoustic signal is reproduced during the ANC;
generating an estimation signal for original noise before the ANC based on the residual signal and the estimation signal for the control signal; and
estimating noise reduction performance based on the estimation signal for the original noise and the residual signal.

2. The method of claim 1, wherein the estimation signal for the original noise is generated by summing the residual signal and the estimation signal for the control signal.

3. The method of claim 1, wherein the estimation signal for the control signal is generated by a secondary path model filter on the basis of an output signal of an active filter.

4. The method of claim 3, wherein the output signal of the active filter is generated by the active filter based on a reference signal generated by an accelerometer, a reference signal filtered by the secondary path model filter, and a residual signal remaining after noise reduction.

5. The method of claim 1, wherein the noise reduction performance is estimated using a value obtained by subtracting a sound pressure level of the residual noise from a sound pressure level of the estimation signal for the original noise.

6. An active noise control system for a vehicle, comprising a processor configured to:
perform active noise control (ANC) by reproducing an acoustic signal for reducing noise introduced from an outside to an inside of the vehicle through a speaker, and receive a residual signal remaining after noise reduction from a microphone;
generate an estimation signal for a control signal for controlling output of the speaker such that the acoustic signal is reproduced during the ANC;
generate an estimation signal for original noise before the ANC based on the residual signal and the estimation signal for the control signal; and
estimate noise reduction performance based on the estimation signal for the original noise.

7. The active noise control system of claim 6, wherein the estimation signal for the original noise is generated by summing the residual signal and the estimation signal for the control signal.

8. The active noise control system of claim 6, wherein the estimation signal for the control signal is generated by a secondary path model filter on the basis of an output signal of an active filter.

9. The active noise control system of claim 8, wherein the output signal of the active filter is generated by the active filter based on a reference signal generated by an accelerometer, a reference signal filtered by the secondary path model filter, and a residual signal remaining after noise reduction.

10. The active noise control system of claim 6, wherein the noise reduction performance is estimated using a value obtained by subtracting a sound pressure level of the residual noise from a sound pressure level of the estimation signal for the original noise.
